(19) United States
(12) Patent Application Publication
(10) Pub. No.: US 2019/0111794 A1
(43) Pub. Date: Apr. 18, 2019

(54) Truck, Charging Arrangement and Method for Electrical Charging

(71) Applicant: MAGNA STEYR Fahrzeugtechnik AG & Co KG, Graz (AT)

(72) Inventor: Rainer SCHRUTH, Graz (AT)

(21) Appl. No.: 16/157,329

(22) Filed: Oct. 11, 2018

(30) Foreign Application Priority Data
Oct. 12, 2017 (EP) 17196128.7
Sep. 18, 2018 (EP) 18195110.4

(51) Int. Cl. B60L 11/18; B62D 53/04; B60P 1/43

(52) U.S. Cl. CPC B60L 11/1816; B62D 53/04; B60K 6/20; B60L 11/1833; B60L 2200/36; B60P 1/43

(57) ABSTRACT

A truck, a charging arrangement, and a method for electrically charging the truck. A body or trailer of the truck is connected to the vehicle for transport of freight. The truck includes a driven vehicle having a driver's cab, a trailer connected to the driven vehicle to receive freight for transport, an electric energy store being arranged on the vehicle, and at least one charging contact arranged on the trailer to electrically charge the energy store.

### CROSS-REFERENCE TO RELATED APPLICATIONS

The present application claims priority 35 U.S.C. § 119 to European Patent Publication Nos. EP 17196128.7 (filed on Oct. 12, 2017) and EP 18195110.4 (filed on Sep. 18, 2018), which are each hereby incorporated by reference in their respective entireties.

### TECHNICAL FIELD

Embodiments relate to a truck comprising a driven vehicle having a driver's cab and an electric energy store, and a body or trailer which is connected to the vehicle for transport of freight. Embodiments further relate to a charging arrangement comprising a truck and a loading ramp for loading and/or unloading freight of the truck, and to a method for electrically charging the truck.

### BACKGROUND

Trucks for transporting freight are well known and may have, in particular, superstructures which are fixedly connected directly to the driven part of the truck (called a “vehicle” here) as containers for freight transport and/or also detachable trailers as containers for freight transport. For example, a body of this type can be formed by way of a flatbed body or box body. A trailer can be attached, for example, and can form a semitrailer as a truck jointly with a tractor unit as a vehicle.

For trucks of this type or vehicles of trucks, it has become known in the meantime that at least one electric motor can be used as a drive, i.e., the trucks are configured, in particular, as electric or hybrid vehicles. Here, the energy store for the electric motor is arranged in the vehicle, usually below the driver's cab. A contact, for example a socket, for charging the energy store is also usually arranged in the vehicle, in the vicinity of the energy store and in the vicinity of the driver's cab.

The electric charging is usually realized via a charging cable which is connected to the charging contact on the vehicle. Alternatives, for example via inductive charging, require a complex infrastructure and are usually less efficient, susceptible to faults or expensive. In particular, trucks with energy stores which are required for the drive have the disadvantage that they have undesirably long down times on account of the necessary electric charging operations, which calls into question the economic efficiency of trucks of this type.

### SUMMARY

In accordance with embodiments, a truck having enhanced features is provided, and, in particular, a truck having electric energy stores which require shorter down times for electric charging.

In accordance with embodiments, a charging arrangement may comprise a truck that includes a driven vehicle having a driver's cab and an electric energy store, a body or trailer which is connected to the vehicle for transport of freight, and a loading ramp for loading and/or unloading freight of the truck, which charging arrangement makes efficient charging of the energy store of the truck possible.

In accordance with embodiments, a method for electrically charging the truck in an efficient manner is provided.

In accordance with embodiments, a truck may comprise a driven vehicle having a driver's cab, a body or trailer which is connected to the vehicle behind the vehicle in the driving direction for freight transport, an electrical energy store being arranged on the body or trailer of the vehicle, and at least one charging contact to electrically charge the electrical energy store arranged on the body or trailer.

In accordance with embodiments, a charging contact for the energy store of the vehicle is not configured in or on the vehicle, but rather on that part of the truck which actually serves merely for freight transport, namely, on the body or particularly on the trailer of the truck. Here, a “charging contact” can comprise a plurality of electric contacts; as a rule, a charging contact comprises two electric poles.

As a result of said position of the electric contact, it is substantially simpler to carry out electric charging during loading or unloading of the truck at a loading station, loading ramp or the like, since that part of the truck which is intended for freight transport usually lies closer to the loading station, loading ramp, etc. than the driven vehicle and the energy store of the vehicle.

By way of an electric charging contact at the rear (on the body or trailer), an electric charging operation during loading and unloading of goods can be simplified and, in particular, also automated, as a result of which electric charging is facilitated which does not lead to any down times which are not necessary in any case on account of the loading and unloading of goods. It is accepted for the advantage according to the invention that much longer electric connector cables to the energy store are usually required for this purpose.

In accordance with embodiments, the energy store is to serve for the drive of the vehicle. The energy store is therefore usually a high voltage battery or drive battery or traction battery. The vehicle therefore has an electric motor which is fed by the energy store. The electric motor serves for the drive of the vehicle. The vehicle can therefore be an electric vehicle or a hybrid vehicle.

In accordance with embodiments, the charging contact is preferably arranged at the rear end (in the driving direction) of the body or trailer. The rear end of the body or trailer is closest to a loading station and can therefore be connected electrically in a very simple way to an electric charging apparatus at the loading station. In this position of the contact, in particular, automatic docking to a charging apparatus during reverse approaching of the truck can also be achieved most simply.

In accordance with embodiments, the charging contact may be arranged at a level spatially below a load bed of the body or trailer. As a result, a simple connection is made possible, and connected charging cables impede the loading and unloading of goods of the truck to a lesser extent.

In accordance with embodiments, an electric line may be routed from the charging contact on the body or trailer as far as the energy store in the vehicle. The electric line may comprise a plug-in connection between the body or trailer on one side and the vehicle on the other side. As a result, the body or trailer can be disconnected electrically from the vehicle. The electric line may be routed from the charging contact over the entire length of the body or trailer as far as the front end of the body or trailer.

In accordance with embodiments, in addition to the electric line, a communication line may be routed from the charging contact as far as the vehicle, the communication line comprising a plug-in connection between the body or trailer on one side and the vehicle on the other side. A communication connection of this type can transmit, for example, a connected/disconnected status of a voltage source at the charging contact or further information about the voltage source to a control unit of the vehicle and/or to a display in the driver's cab.

In accordance with embodiments, a charging arrangement comprises a truck as described above and a loading ramp for loading and/or unloading freight at the rear end of a body or trailer of the truck, a charging counter-contact arranged on the loading ramp and configured to pass into electrically conducting contact with the charging contact of the truck, in particular, to pass automatically into contact during a reversing approach of the body or trailer to the loading ramp.

In accordance with embodiments, “loading ramp” is to be understood not only in the strict sense of the ramp itself, but rather also in a broader sense as a loading region for loading and unloading goods, which loading region comprises a ramp. The charging counter-contact does not have to be arranged directly on a ramp face of the loading ramp to this end, but rather can be arranged in any desired manner in the region of the loading ramp, but at an end of the loading ramp which faces a docking truck. By way of its charging counter-contact and a voltage source which is connected to it, the “loading ramp” which is configured first of all for loading and unloading goods also becomes an electric “charging” station.

In accordance with embodiments, the charging counter-contact and/or the charging contact may be of flexible, in particular elastic, configuration, in order to facilitate an automatic connection between the charging contact and the charging counter-contact.

In accordance with embodiments, a method for electrically charging a truck of this type may comprise reversing the truck up to a loading ramp (e.g., a loading ramp as described above) for loading or unloading freight; establishing contact between the charging contact of the body or trailer and a counter-contact on the loading ramp by way of the reversing up to the loading ramp; and electrically charging the energy store of the vehicle by the loading ramp via the charging contact and the charging counter-contact during loading or unloading of freight into/from the body or trailer.

### DRAWINGS

Embodiments will be illustrated by way of example in the drawings and explained in the description below.

FIG. 1 illustrates a diagrammatic illustration of a truck, in accordance with embodiments.

### DESCRIPTION

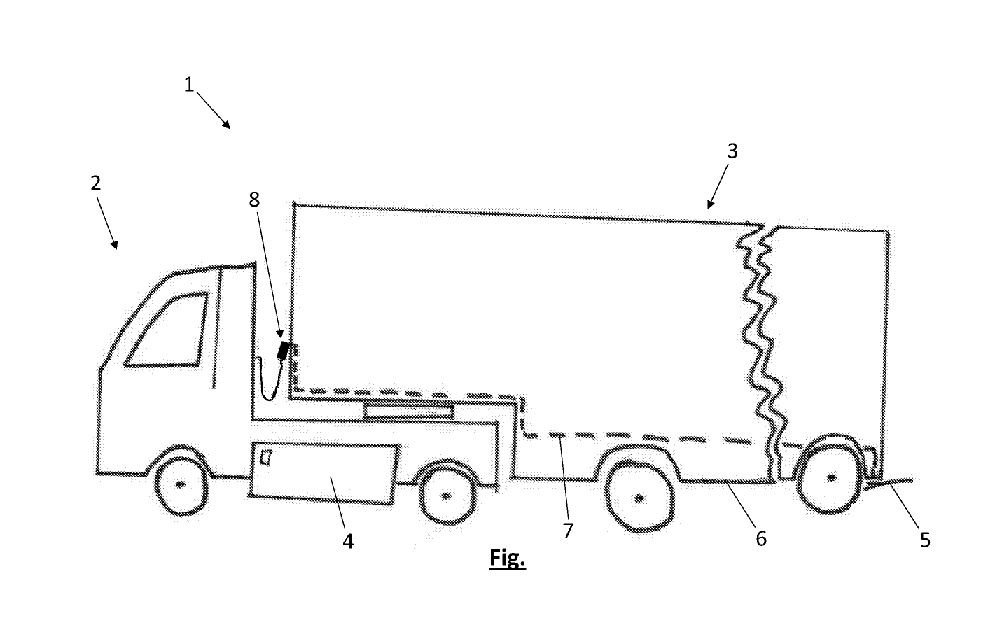

As illustrated in FIG. 1, a truck 1, such as, for example, an electrically driven truck 1, in accordance with embodiments comprises a vehicle 2 as a tractor unit which drives the truck 1 by way of an electric motor and has a driver's cab. An energy store 4 for the driving electric motor is arranged on the vehicle 2. In a usual driving direction, i.e., in the case of forward driving of the truck 1, a trailer 3 is connected to the vehicle 2 and arranged spatially behind the vehicle 2 for freight transport. Below a load bed 6 of the trailer 3, one or more charging contacts 5 for electrically charging the energy store 4 is arranged at the rear end of the trailer 3.

An electric line 7 is routed from the charging contact 5 to as far as the energy store 4 in the vehicle 2 to electrically connect the charging contact 5 to the energy store 4 and thereby electrically charge the energy store 4. The electric line 7 may be configured in a plurality of electric line sections, and may be interrupted or connected in an electrically conducting manner between the trailer 3 and the vehicle 2 via a plug-in connection 8. The electric line 7 extends from the charging contact 5 over the entire length of the trailer 3 as far as the front end of the trailer 3. A voltage supply is relayed via the body or trailer 3 into the vehicle 2 or the energy store 4 of the truck, in particular, the electric truck 1.

In addition to the electric line 7, a communication line (not illustrated) is routed from the charging contact 5 as far as the vehicle 2, which communication line makes a connection once again via a plug-in connection, in particular, in the region of the current-charging plug-in connection 8, between the trailer 3 and the vehicle 2.

A truck 1 in accordance with embodiments may be charged electrically via a loading ramp for loading and/or unloading freight, which loading ramp has a charging counter-contact for connecting to the charging contact 5 of the truck 1. The connection (physical and/or electrical) between the charging counter-contact and the charging contact 5 may be established automatically when the truck approaches the loading ramp and therefore the charging counter-contact while reversing the truck 1. In particular, automated electric charging operations, during the time in which the truck 1 is docked anyway at the loading ramp, may reduce idle times of the truck 1. Therefore, a three-shift operation or permanent operation of the vehicle 2 may also be possible by way of a truck 1 in accordance with embodiments.

In operation, during reversing maneuvering of the truck 1 to a loading ramp or into a dock, the body or trailer 3 drives up to the ramp in a flush manner in order to load the goods. During this operation, the contact(s) 5 which are attached on the vehicle 1 underside are connected (physically and/or electrically) to the contacts of the loading ramp. For example, this takes place via individual contacts which may be guided in individual rails. By way of this operation, the entire truck 1 becomes a type of charging pole during the connection. The power for charging the energy store 4 is switched on only after the locking of the plug-in connections and the correct connection of all lines and communication channels. Electric charging of the drive battery of an electric truck or electric truck traction unit is made possible, without the driver having to get out to this end or having to manually plug a power cable into the truck.

In accordance with embodiments, the contact(s) 5 for charging the energy store 4 is brought about on the trailer 3, in particular, at the rear of the trailer 3 or semitrailer or body. To this end, as is usual, the truck driver may drive the truck 1 in reverse gear into the goods loading/unloading dock, i.e., the loading ramp, on which an electric charging station or its charging contacts, the charging counter-contact, is situated. The electric contacts which are situated on the rear side of the load bed and below the load bed (e.g., between the rear axle and the rear lights) in the end region of the truck electrically connect automatically or by themselves to the electric counterpart in the dock upon approach, as a result of the reversing movement of the truck including its trailer 3 or semitrailer. Here, electric contact is therefore made at the same time (in a flush manner in the dock) by way of the trailer 3 or semitrailer driving up to a customary end station in a flush manner.

Here, the electric contacts, that is to say the charging contact(s) 5, are by way of example, of elongate design on the truck, for example as blade contacts, the longitudinal side of which points in the driving direction, with the result that it is possible for the contacts (charging contact 5) to bear tightly against the contacts of the stationary counterpart (charging counter-contact) in a sliding manner by way of the linear reverse driving movement. The charging counter-contact of the stationary device and/or the charging contact 5 on the truck has a resilience, in order not to damage the electric contacts in the case of incorrect driving maneuvers. The charging counter-contacts of the stationary device, and also the charging contact(s) 5 on the body or trailer 3, are fundamentally mounted fixedly.

In accordance with embodiments, there may be a total of two contact points, in particular plug-in connections, in the electric line 7 from the voltage source as far as the energy store 4. On one side, a first contact point at the plugin connection 8 between the vehicle 2, in particular the traction unit, and the trailer 3 or semitrailer and, a second contact point on the other side, between the trailer 3 or semitrailer and the stationary charging device. In this solution, the charging current to the battery, the energy store 4, is conducted via the trailer 3 or semitrailer, and the body. The power for charging the battery is switched on only after locking of all plug-in connections and the correct connection of all lines and communication channels.

The truck 1 may be steered by hand. Optionally, the vehicle 2 and therefore the truck can drive automatically or autonomously. The vehicle 2 of the truck 1 may therefore be an autonomously controlled vehicle.

The terms “coupled,” “attached,” or “connected” may be used herein to refer to any type of relationship, direct or indirect, between the components in question, and may apply to electrical, mechanical, fluid, optical, electromagnetic, electromechanical or other connections. In addition, the terms “first,” “second,” etc. are used herein only to facilitate discussion, and carry no particular temporal or chronological significance unless otherwise indicated.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

### LIST OF REFERENCE NUMERALS

1 Truck
2 Vehicle
3 Trailer
4 Energy store
5 Charging contact
6 Load bed
7 Electric line
8 Plug-in connection

What is claimed is:

1. A truck, comprising:
a driven vehicle having a driver's cab;
a trailer connected to the driven vehicle to receive freight for transport;
an electric energy store being arranged on the vehicle; and
at least one charging contact arranged on the trailer to electrically charge the energy store.

2. The truck of claim 1, wherein the at least one charging contact is spatially positioned at a rear end of the trailer.

3. The truck of claim 1, wherein the at least one charging contact is spatially positioned below a load bed of the trailer.

4. The truck of claim 1, further comprising an electric line extending between the at least one charging contact and the energy store to establish electric contact between the at least one charging contact and the energy store.

5. The truck of claim 4, wherein the electric line comprises a plug-in connection spatially positioned between the trailer and the vehicle.

6. The truck of claim 4, wherein the electric line extends from the at least one charging contact through an entire length of the trailer and terminates at a front end of the trailer.

8. A charging system, comprising:
a truck having:
a driven vehicle having a driver's cab;
a trailer connected to the driven vehicle to receive freight for transport;
an electric energy store being arranged on the vehicle; and
at least one charging contact arranged on the trailer to electrically charge the energy store, and
a loading ramp to facilitate loading and/or unloading of the freight at a rear end of the trailer, the loading ramp having a charging counter-contact configured to automatically contact the at least one charging contact during a reversing approach of the trailer to the loading ramp.

9. The charging system of claim 8, wherein the at least one charging contact is spatially positioned at a rear end of the trailer.

10. The charging system of claim 8, wherein the at least one charging contact is spatially positioned below a load bed of the trailer.

11. The charging system of claim 8, further comprising an electric line extending between the at least one charging contact and the energy store to establish electric contact between the at least one charging contact and the energy store.

12. The charging system of claim 11, wherein the electric line comprises a plug-in connection spatially positioned between the trailer and the vehicle.

13. The charging system of claim 11, wherein the electric line extends from the at least one charging contact through an entire length of the trailer and terminates at a front end of the trailer.

14. A method for electrically charging a truck, the method comprising:
electrically charging an energy store of the truck by establishing electrically conducting contact between at least one charging contact of the trailer and a counter-contact of a loading ramp by reversing the truck towards the loading ramp to load or unload freight contained in the trailer of the truck, wherein the energy store is electrically charged during the loading or unloading of the freight.
